(19) United States
(12) Patent Application Publication
(10) Pub. No.: US 2005/0190156 A1
(43) Pub. Date: Sep. 1, 2005

(54) Wireless input devices

(75) Inventor: Chun-Chung Huang, Taipei (TW)

Correspondence Address: BIRCH STEWART KOLASCH & BIRCH, PO BOX 747, FALLS CHURCH, VA, 22040-0747, US

(73) Assignee: Darfon Electronics Corp.

(21) Appl. No.: 11/063,555

(22) Filed: Feb. 24, 2005

(30) Foreign Application Priority Data
Feb. 27, 2004 (TW) 93202867

(51) Int. Cl. G09G 5/08

(52) U.S. Cl. 345/163

(57) ABSTRACT

Wireless input devices for a computer are provided. A wireless input device includes a main body and a receiver detachably connected to a peripheral of the main body. The receiver receives a radio signal from the main body when the receiver is separated from the main body and connected to the computer.

### BACKGROUND

The invention relates in general to wireless input devices and in particular to wireless input devices comprising a main body and a receiver detachably connected, thus facilitating convenient use and integration.

Referring to FIG. 1, a conventional wireless input device, such as a wireless mouse device, primarily comprises a main body M and a receiver R. When the receiver R electrically connects to a computer C, the main body M of the wireless mouse device is normally operated by sliding on a surface (not shown). The main body M emits a signal, such as an IR or electromagnetic signal, converted to an electrical signal by the receiver R for application in the computer C, enabling input of data to the computer C via the main body M. Since the main body M and the receiver R are separated, however, it is not convenient without integration and the receiver may be lost.

### SUMMARY

Wireless input devices are provided. An exemplary embodiment of a wireless input device includes a main body and a receiver detachably connected to a peripheral of the main body. The receiver receives a radio signal from the main body when the receiver is separated from the main body and connected to the computer.

### DESCRIPTION OF THE DRAWINGS

FIG. 1 is a perspective diagram of a conventional wireless input device;

FIGS. 2a, 2b and 2c are perspective diagrams of an exemplary embodiment of a wireless input device with a receiver connected to a main body;

FIGS. 3a and 3b are perspective diagrams of an exemplary embodiment of a wireless input device with a receiver connected to a sliding surface of a main body;

FIG. 4 is a perspective diagram of an exemplary embodiment of a wireless input device with a receiver connected to a lateral surface of a main body; and

FIG. 5 is a perspective diagram of an exemplary embodiment of a wireless input device with a receiver connected to an operating surface of a main body.

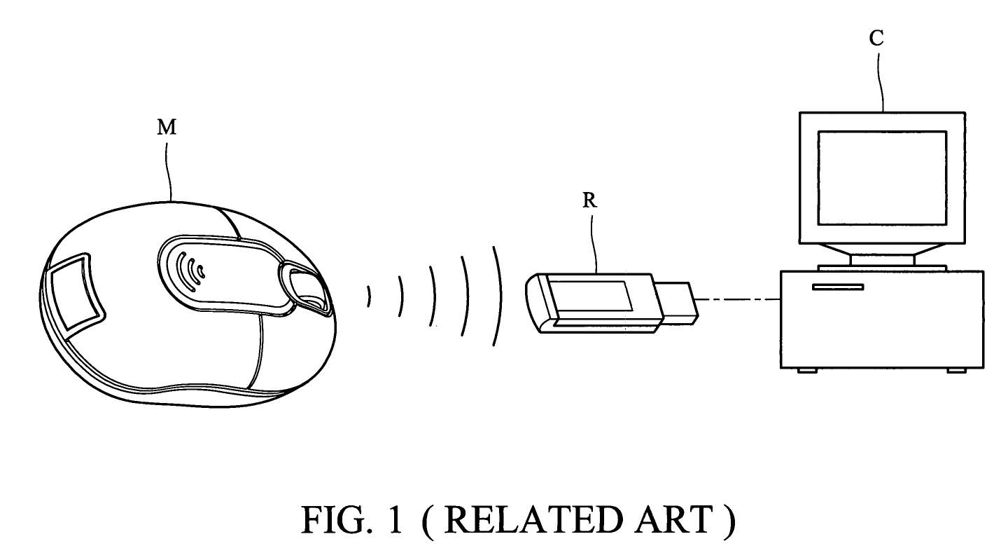

### DETAILED DESCRIPTION

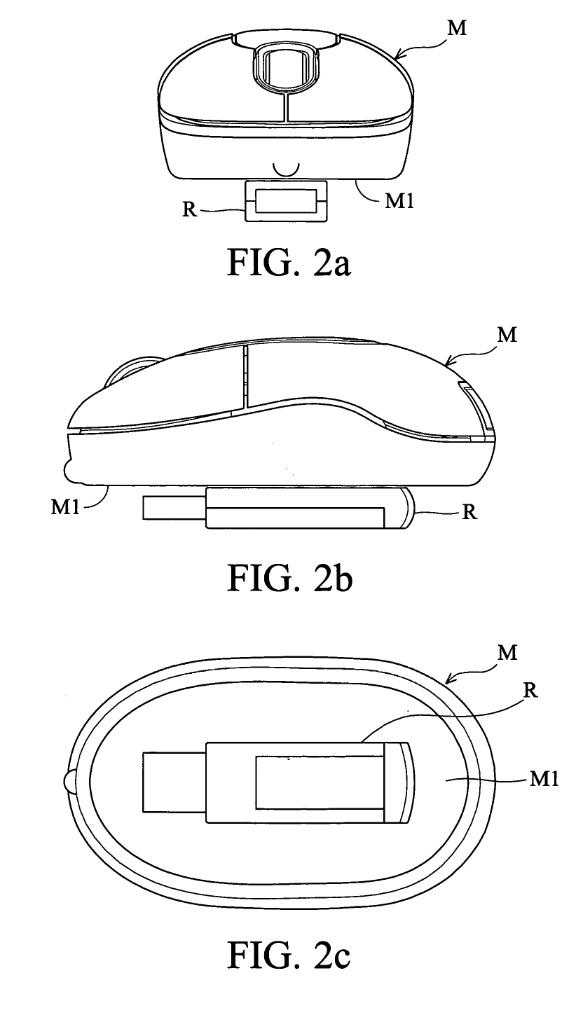

Referring to FIGS. 2a, 2b and 2c, an exemplary embodiment of a wireless input device, such as a wireless mouse device, primarily comprises a main body M and a receiver R detachably connected. To enable use of the wireless mouse device, the receiver R is detached from the main body M and electrically connected to a computer (not shown). The main body M emits a radio signal to the receiver R during movement of the main body M with respect to a surface such as a table, under the sliding surface M1. The radio signal can be an IR signal or an electromagnetic signal, enabling input of data to the computer.

As shown in FIGS. 2a, 2b and 2c, as the receiver R adheres to the sliding surface M1 at the bottom of the main body M, convenient integration is accomplished. In some embodiments, the main body M and the receiver R both comprise magnetic material, thus attracting each other and facilitating convenient connection.

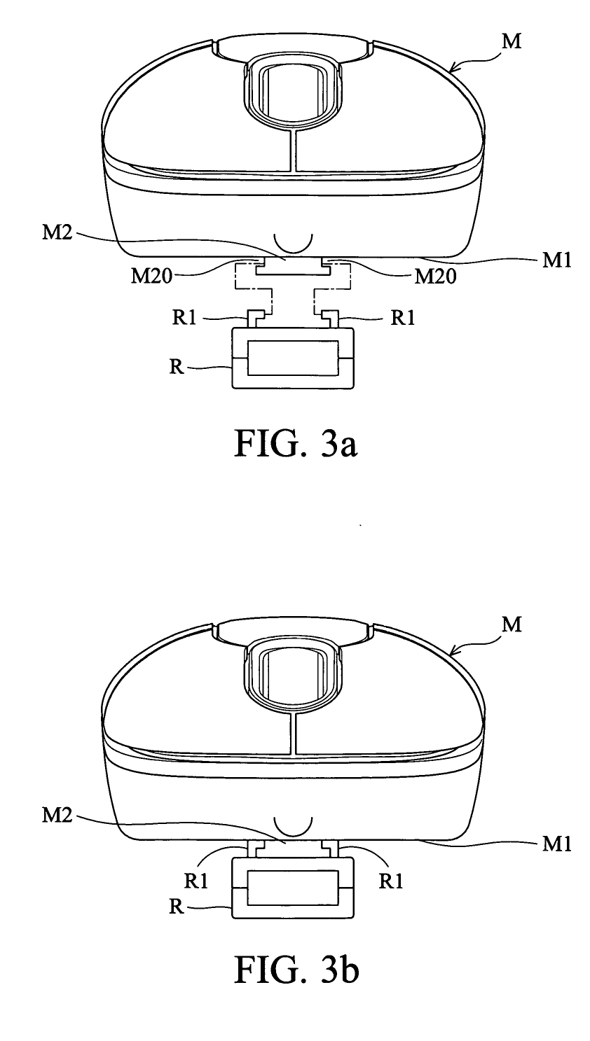

In FIG. 3a, an exemplary embodiment of the main body M comprises a T-shaped protrusion M2 projecting from the sliding surface M1 at the bottom of the main body M. The T-shaped protrusion M2 forms two guide slots M20 on both sides thereof. Correspondingly, the receiver R comprises two projecting L-shaped connecting portions R1 detachably joined in the guide slots M20. As shown in FIG. 3b, the main body M and the receiver R can be easily integrated by joining the connecting portions R1 in the guide slots M20.

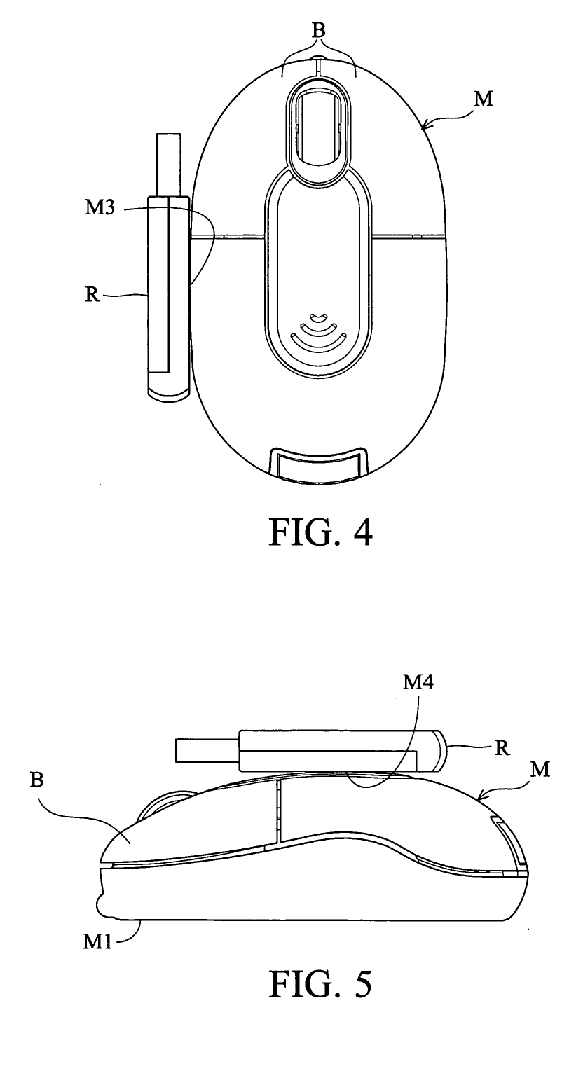

Referring to FIG. 4, the receiver R can also be detachably adhered to a lateral surface M3 of the main body M. The lateral surface M3 is substantially perpendicular to the sliding surface M1. In some embodiments, the main body M and the receiver R can be connected by magnetic force, facilitating convenient integration. In some embodiments, the main body M and the receiver R can also be integrated on the lateral surface M3 by other connection means, such as the connecting portion R1 and the guide slot M20 correspondingly joining to each other as shown in FIGS. 3a and 3b.

As shown in FIG. 5, the receiver R can also be detachably adhered to an operating surface M4 of the main body M. The operating surface M4 is curved with a pair of buttons B disposed thereon for data input. In some embodiments, the main body M and the receiver R can be connected by magnetic force for convenient integration. In some embodiments, the main body M and the receiver R can also be integrated on the operating surface M4 by other connection means, such as the connecting portion R1 and the guide slot M20 correspondingly joining to each other in FIGS. 3a and 3b.

In summary, a wireless input device with a receiver detachably connected to the peripheral of a main body are provided. As the receiver and the main body can be alternatively connected or separated from each other, it is convenient to use and integrate preventing the receiver being lost.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation to encompass all such modifications and similar arrangements.

1. A wireless input device for a computer, comprising:
a main body; and
a receiver detachably connected to the peripheral of the main body, wherein the receiver receives a radio signal from the main body when the receiver is separated from the main body and connected to the computer.

2. The wireless input device as claimed in claim 1, wherein the main body is a wireless mouse.

3. The wireless input device as claimed in claim 2, wherein the main body comprises a sliding surface moving with respect to a base surface.

4. The wireless input device as claimed in claim 3, wherein the receiver is connected to the sliding surface.

5. The wireless input device as claimed in claim 3, wherein the main body further comprises a lateral surface substantially perpendicular to the sliding surface, and the receiver is connected to the lateral surface.

6. The wireless input device as claimed in claim 1, wherein the main body comprises an operating surface and a button disposed thereon, and the receiver is connected to the operating surface.

7. The wireless input device as claimed in claim 1, wherein the receiver is connected to the main body by magnetic force.

8. The wireless input device as claimed in claim 1, wherein the main body comprises a guide slot with the receiver movably joined therein, so as to connect the receiver and the main body.

9. The wireless input device as claimed in claim 8, wherein the main body comprises a protrusion with the guide slot formed thereon.

10. The wireless input device as claimed in claim 8, wherein the receiver comprises a connecting portion joined in the guide slot when the receiver is connected to the main body.

11. The wireless input device as claimed in claim 10, wherein the connecting portion is L-shaped, and projects from the receiver.
